(19) United States
(12) Patent Application Publication
(10) Pub. No.: US 2024/0373260 A1
(43) Pub. Date: Nov. 7, 2024

(54) COMMUNICATION METHOD AND COMMUNICATIONS APPARATUS

(71) Applicant: GUANGDONG OPPO MOBILE TELECOMMUNICATIONS CORP., LTD., Dongguan (CN)

(72) Inventors: Yang XU, Dongguan (CN); Jingran CHEN, Dongguan (CN)

(21) Appl. No.: 18/776,679

(22) Filed: Jul. 18, 2024

Related U.S. Application Data
(63) Continuation of application No. PCT/CN2022/073317, filed on Jan. 21, 2022.

(51) Int. Cl. H04W 24/02; H04W 24/08; H04W 28/02

(52) U.S. Cl. CPC H04W 24/02; H04W 24/08; H04W 28/0268

(57) ABSTRACT

Disclosed are a communication method and a communications apparatus. The method includes: obtaining, by a monitoring node, a monitoring result of a quality of service QoS parameter of at least one terminal device, where the monitoring node is a user plane network element or a control plane network element; determining, by the monitoring node from the monitoring result of the QoS parameter of the at least one terminal device, a first monitoring result that meets a preset condition; and sending, by the monitoring node, first information to a notified node, where the first information is used to indicate the first monitoring result, and the notified node includes a control plane network element, an application server, or a terminal device.

### CROSS-REFERENCE TO RELATED APPLICATIONS

This application is a continuation of International Application No. PCT/CN2022/073317, filed on Jan. 21, 2022, the disclosure of which is hereby incorporated by reference in its entirety.

### TECHNICAL FIELD

This application relates to the field of communications technologies, and more specifically, to a communication method and a communications apparatus.

### BACKGROUND

With development of communications technologies, a quality of service (QOS) mechanism is introduced to some communications systems, to ensure a transmission rate. Currently, nodes (such as a user equipment (UE), an access network element (RAN), a user plane network element (UPF)) that are configured to execute QoS have a capability of measuring a QoS parameter. However, it is not clear yet how to monitor the QoS parameter based on the nodes.

### SUMMARY

This application provides a communication method and a communications apparatus, to implement monitoring of a QoS parameter.

According to a first aspect, a communication method is provided, and the method includes: obtaining, by a monitoring node, a monitoring result of a quality of service QoS parameter of at least one terminal device, where the monitoring node is a user plane network element or a control plane network element; determining, by the monitoring node from the monitoring result of the QoS parameter of the at least one terminal device, a first monitoring result that meets a preset condition; and sending, by the monitoring node, first information to a notified node, where the first information is used to indicate the first monitoring result, and the notified node includes a control plane network element, an application server, or a terminal device.

According to a second aspect, a communication method is provided, and the method includes: obtaining, by an access network element, a monitoring result of a quality of service QoS parameter of at least one terminal device; and sending, by the access network element, third information to a monitoring node, where the third information is used to indicate the monitoring result of the QoS parameter of the at least one terminal device, and the monitoring node is a user plane network element or a control plane network element.

According to a third aspect, a communication method is provided, and the method includes: performing monitoring, by a terminal device, to obtain a monitoring result of a quality of service QoS parameter; and sending, by the terminal device, fourth information to a monitoring node, where the fourth information is used to indicate the monitoring result of the QoS parameter, and the monitoring node is a user plane network element or a control plane network element.

According to a fourth aspect, a communication method is provided, and the method includes: receiving, by a notified node, first information sent by a monitoring node, where the first information is used to indicate a first monitoring result that meets a first preset condition in a monitoring result of a quality of service QoS parameter of at least one terminal device, the notified node includes a control plane network element, an application server, or a terminal device, and the monitoring node is a user plane network element or a control plane network element.

According to a fifth aspect, a communication method is provided, and the method includes: receiving, by a notified node, third information sent by an access network element, where the third information is used to indicate a monitoring result of a quality of service QoS parameter of at least one terminal device, and the notified node includes a control plane network element, an application server, or a terminal device; and determining, by the notified node from the monitoring result of the QoS parameter of the at least one terminal device, a second monitoring result that meets a second preset condition.

According to a sixth aspect, a communication method is provided, and the method includes: receiving, by a notified node, fourth information sent by a terminal device, where the fourth information is used to indicate a monitoring result of the QoS parameter, and the notified node includes a control plane network element, an application server, or a terminal device; and determining, by the notified node, a third monitoring result that meets a third preset condition according to the monitoring result of the QoS parameter.

According to a seventh aspect, a communications apparatus is provided, and the apparatus includes: an obtaining unit, configured to obtain a monitoring result of a quality of service QoS parameter of at least one terminal device, where the apparatus is a user plane network element or a control plane network element; a determining unit, configured to determine, from the monitoring result of the QoS parameter of the at least one terminal device, a first monitoring result that meets a first preset condition; and a sending unit, configured to send first information to a notified node, where the first information is used to indicate the first monitoring result.

According to an eighth aspect, a communications apparatus is provided, and the apparatus includes: an obtaining unit, configured to obtain a monitoring result of a quality of service QoS parameter of at least one terminal device; and a sending unit, configured to send third information to a monitoring node, where the third information is used to indicate the monitoring result of the QoS parameter of the at least one terminal device, and the monitoring node is a user plane network element or a control plane network element.

According to a ninth aspect, a communications apparatus is provided, and the apparatus includes: a monitoring unit, configured to perform monitoring to obtain a monitoring result of a quality of service QoS parameter; and a sending unit, configured to send fourth information to a monitoring node, where the fourth information is used to indicate the monitoring result of the QoS parameter, and the monitoring node is a user plane network element or a control plane network element.

According to a tenth aspect, a communications apparatus is provided, and the apparatus includes: a receiving unit, configured to receive first information sent by a monitoring node, where the first information is used to indicate a first monitoring result that meets a first preset condition in a monitoring result of a quality of service QoS parameter of at least one terminal device, where the apparatus includes a control plane network element, an application server, or a terminal device, and the monitoring node is a user plane network element or a control plane network element.

According to an eleventh aspect, a communications apparatus is provided, and the apparatus includes: a receiving unit, configured to receive third information sent by an access network element, where the third information is used to indicate a monitoring result of a quality of service QoS parameter of at least one terminal device; and a determining unit, configured to determine, from the monitoring result of the QoS parameter of the at least one terminal device, a second monitoring result that meets a second preset condition.

According to a twelfth aspect, a communications apparatus is provided, and the apparatus includes: a receiving unit, configured to receive fourth information sent by a terminal device, where the fourth information is used to indicate a monitoring result of the QoS parameter; and a determining unit, configured to determine a third monitoring result that meets a third preset condition according to the monitoring result of the QoS parameter.

According to a thirteenth aspect, a communications apparatus is provided, and the apparatus includes a memory and a processor, where the memory is configured to store a program, and the processor is configured to invoke the program in the memory, to execute the method according to any one of the first aspect, the second aspect, the third aspect, the fourth aspect, the fifth aspect, or the sixth aspect.

According to a fourteenth aspect, a communications apparatus is provided, and the apparatus includes a processor configured to invoke a program from a memory, to execute the method according to any one of the first aspect, the second aspect, the third aspect, the fourth aspect, the fifth aspect, or the sixth aspect.

According to a fifteenth aspect, a chip is provided, and the chip includes a processor configured to invoke a program from a memory, to cause a device on which the chip is installed to execute the method according to any one of the first aspect, the second aspect, the third aspect, the fourth aspect, the fifth aspect, or the sixth aspect.

According to a sixteenth aspect, a computer-readable storage medium is provided, where the computer-readable storage medium stores a program, and the program causes a computer to execute the method according to any one of the first aspect, the second aspect, the third aspect, the fourth aspect, the fifth aspect, or the sixth aspect.

According to a seventeenth aspect, a computer program product is provided. The computer program product includes a program, where the program causes a computer to execute the method according to any one of the first aspect, the second aspect, the third aspect, the fourth aspect, the fifth aspect, or the sixth aspect.

According to an eighteenth aspect, a computer program is provided, where the computer program causes a computer to execute the method according to any one of the first aspect, the second aspect, the third aspect, the fourth aspect, the fifth aspect, or the sixth aspect.

In embodiments of this application, a monitoring node obtains a monitoring result of a quality of service QoS parameter of at least one terminal device, determines, from the monitoring result of the QoS parameter of the at least one terminal device, a first monitoring result that meets a first preset condition, and sends the first monitoring result to a notified node, so that monitoring of the QoS parameter can be implemented.

### BRIEF DESCRIPTION OF DRAWINGS

FIG. 1 is an example diagram of a wireless communications system to which embodiments of this application are applicable.

FIG. 2 is an example diagram of a 5GS architecture according to an embodiment of this application.

FIG. 3 is a schematic flowchart of a communication method according to an embodiment of this application.

FIG. 4 is a schematic flowchart of a communication method according to another embodiment of this application.

FIG. 5 is a schematic flowchart of a communication method according to still another embodiment of this application.

FIG. 6 is a schematic flowchart of a communication method according to yet another embodiment of this application.

FIG. 7 is a schematic flowchart of a communication method according to still yet another embodiment of this application.

FIG. 8 is a schematic flowchart of a communication method according to a further embodiment of this application.

FIG. 9 is a schematic flowchart of a communication method according to a still further embodiment of this application.

FIG. 10 is a schematic structural diagram of a communications apparatus according to an embodiment of this application.

FIG. 11 is a schematic structural diagram of a communications apparatus according to another embodiment of this application.

FIG. 12 is a schematic structural diagram of a communications apparatus according to still another embodiment of this application.

FIG. 13 is a schematic structural diagram of a communications apparatus according to yet another embodiment of this application.

FIG. 14 is a schematic structural diagram of a communications apparatus according to still yet another embodiment of this application.

FIG. 15 is a schematic structural diagram of a communications apparatus according to a further embodiment of this application.

FIG. 16 is a schematic structural diagram of an apparatus according to an embodiment of this application.

### DESCRIPTION OF EMBODIMENTS

The following describes the technical solutions in this application with reference to the accompanying drawings.

FIG. 1 shows a wireless communications system 100 to which embodiments of this application are applicable. The wireless communications system 100 may include a network device 110 and a user equipment (UE) 120. The network device 110 may communicate with the UE 120. The network device 110 may provide communication coverage for a specific geographic area, and may communicate with a UE 120 within the coverage area. The UE 120 may access a network (for example, a wireless network) by using the network device 110.

FIG. 1 exemplarily shows one network device and two UEs. Optionally, the wireless communications system 100 may include a plurality of network devices, and another quantity of terminal devices may be included within coverage of each network device, which is not limited in embodiments of this application. Optionally, the wireless communications system 100 may further include other network entities such as a network controller and a mobility management entity, which is not limited in embodiments of this application.

It should be understood that technical solutions of embodiments of this application may be applied to various communications systems, such as a 5th generation (5G) system or new radio (NR), a long-term evolution (LTE) system, an LTE frequency division duplex (FDD) system, and LTE time division duplex (TDD). The technical solutions provided in this application may further be applied to a future communications system, such as a sixth generation mobile communications system or a satellite communications system.

The UE in embodiments of this application may also be referred to as a terminal device, an access terminal, a user unit, a user station, a mobile site, a mobile station (MS), a mobile terminal (MT), a remote station, a remote terminal, a mobile device, a user terminal, a terminal, a wireless communications device, a user agent, or a user apparatus. The UE in embodiments of this application may be a device providing a user with voice and/or data connectivity and capable of connecting people, objects, and machines, such as a handheld device or vehicle-mounted device having a wireless connection function. The UE in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, or the like. Optionally, the UE may be used to function as a base station. For example, the UE may function as a scheduling entity, which provides a sidelink signal between UEs in V2X, D2D, or the like. For example, a cellular phone and a vehicle communicate with each other by using a sidelink signal. A cellular phone and a smart home device communicate with each other, without relaying a communication signal by using a base station.

The network device in embodiments of this application may be a device for communicating with the UE. The network device may also be referred to as an access network device or a radio access network device. For example, the network device may be a base station. The network device in embodiments of this application may be a radio access network (RAN) node (or device) via which the UE is connected to a wireless network. The base station may broadly cover various the following names, or may be replaced with the following names: a NodeB, an evolved NodeB (eNB), a next generation NodeB (gNB), a relay station, an access point, a transmitting and receiving point (TRP), a transmitting point (TP), a primary MeNB, a secondary SeNB, a multi-standard radio (MSR) node, a home base station, a network controller, an access node, a wireless node, an access point (AP), a transmission node, a transceiver node, a base band unit (BBU), a remote radio unit (RRU), an active antenna unit (AAU), a remote radio head (RRH), a central unit (CU), a distributed unit (DU), a positioning node, or the like. The base station may be a macro base station, a micro base station, a relay node, a donor node, or the like, or a combination thereof.

In some embodiments, the network device may be fixed or mobile. For example, a helicopter or an unmanned aerial vehicle may be configured to function as a mobile network device, and one or more cells may move depending on a location of the mobile network device. In other examples, a helicopter or an unmanned aerial vehicle may be configured to function as a device that communicates with another network device. In some embodiments, the network device may be a CU or a DU, or the network device may include a CU and a DU, or the network device may further include an AAU.

It should be understood that the network device may be deployed on land, including being indoors or outdoors, handheld, or vehicle-mounted, may be deployed on a water surface, or may be deployed on a plane, a balloon, or a satellite in the air. In embodiments of this application, the network device and a scenario in which the network device is located in embodiments of this application are not limited.

It should also be understood that all or some of functions of the network device and the UE in this application may also be implemented by software functions running on hardware, or by virtualization functions instantiated on a platform (for example, a cloud platform).

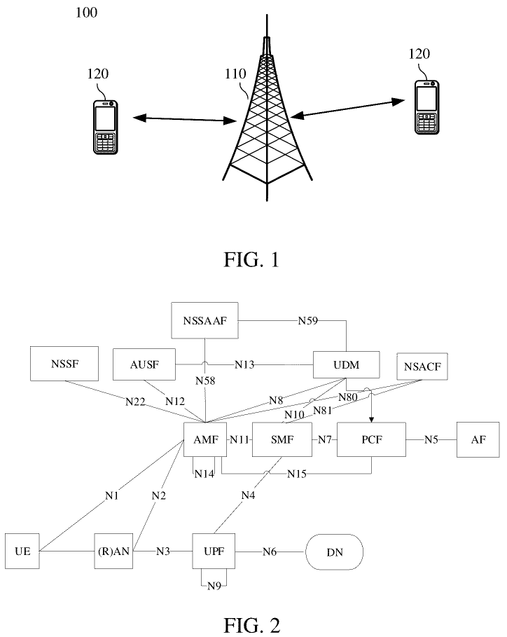

The following describes the solutions in embodiments of this application using FIG. 2 as an example.

FIG. 2 is a diagram of an architecture of a 5Gsystem (5GS), which includes network elements such as a network slice specific authentication and authorization function (NSSAAF), a network slice selection function (NSSF), an authentication server function (AUSF), unified data management (UDM), a network slice admission control function (NSACF), an access and mobility management function (AMF), a session management function (SMF), a policy control function (PCF), an application function (AF), a UE, a RAN, a UPF, and a data network (DN).

Embodiments of this application relate to a terminal device (the UE), an access network element (the RAN), a control plane network element (for example, the PCF or the SMF), and a user plane network element (for example, the UPF) in FIG. 2. The access network element may be the network device 110 in FIG. 1, and the terminal device may be the user equipment 120 in FIG. 1.

As shown in FIG. 2, the terminal device may establish a packet data unit (PDU) session (that is, a connection between the UE and the UPF in FIG. 2) by interacting with the control plane network element. When sending uplink data, the terminal device may send the uplink data to the user plane network element by using a protocol for the PDU session. The user plane network element may perform next-hop routing according to an IP address of a target server, and finally send the uplink data to an application server (for example, a server on the DN). For a downlink data type, after receiving a data packet from the application server, the user plane network may determine, according to a downlink target IP address, to bind to a corresponding PDU session, and send the downlink data to the terminal device by using the PDU session.

Quality of service (QOS) is an important standard for measuring communication quality. With development of communications technologies, a QoS mechanism is introduced to some communications systems, to ensure a transmission rate. Currently, nodes (such as a user equipment (UE), an access network element (radio access network, RAN), and a user plane network element (user plane function, UPF)) that are configured to execute QoS have a capability of measuring a QoS parameter. However, it is not clear yet how to monitor the QoS parameter based on the nodes.

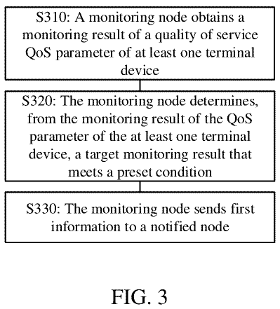

To resolve one or more of the foregoing technical problems, this application provides a communication method and a communications apparatus. Monitoring of a QoS parameter can be implemented in Embodiments of this application. With reference to FIG. 3 to FIG. 9, the following describes embodiments of this application in detail by using examples.

FIG. 3 is a schematic flowchart of a communication method according to an embodiment of this application. The method 300 shown in FIG. 3 may include steps S310, S320, and S330, which are specifically as follows:

S310: A monitoring node obtains a monitoring result of a quality of service QoS parameter of at least one terminal device.

The monitoring node may be a user plane network element or a control plane network element. Optionally, the user plane network element may be the UPF shown in FIG. 2, and the control plane network element may be the PCF, the SMF, or the like shown in FIG. 2.

Optionally, the QoS parameter may include a guaranteed bit rate (GBR), a maximum bit rate (MBR), and/or an aggregated maximum bit rate (AMBR).

In this embodiment of this application, the monitoring result may be a result of measurement of the QoS parameter. For example, the result of the measurement may include a real-time measurement result of a latency, a real-time measurement result of a UE-AMBR, a real-time measurement result of a rate, or the like. Alternatively, the monitoring result may also be an evaluation result of a real-time change of the QoS parameter. For example, the evaluation result may be used to indicate that a GBR cannot continue to be met due to a change of a factor such as an air interface or a load of a wired network.

Optionally, the monitoring result of the QoS parameter may include a guarantee status of a QoS flow, a current rate obtained through measurement, current reliability, and/or a current latency.

In this embodiment of this application, the guarantee status of a QoS flow may be whether one or more of QoS parameters corresponding to the QoS flow may continue to be executed, or whether there is a possibility of the one or more of QoS parameters corresponding to the QoS flow being damaged in the future.

For example, currently, there is already a QoS management and control mechanism in a system. Therefore, the existing management and control mechanism may be used to monitor whether a QoS parameter can be guaranteed or can not be guaranteed in the future, and a monitoring result is reported to a user plane network element or a control plane network element of a core network. Alternatively, a new measurement parameter may be added or a data packet in a QoS flow may be marked, to measure whether a QoS parameter can be guaranteed, and a measurement result is reported to a user plane network element or a control plane network element of a core network.

Optionally, the QoS parameter may include a rate parameter (in the QoS parameter).

For example, the rate parameter may include one or more of the following parameters: a guaranteed bit rate (GBR), a maximum bit rate (MBR), a user equipment aggregated maximum bit rate (UE aggregated maximum bit rate, UE-AMBR), or a session aggregated maximum bit rate (session-AMBR).

S320: The monitoring node determines, from the monitoring result of the QoS parameter of the at least one terminal device, a first monitoring result that meets a first preset condition.

The first preset condition may include: a terminal device whose rate is greater than a preset threshold in the at least one terminal device, a terminal device whose rate is less than the preset threshold in the at least one terminal device, n terminal devices whose rates are the largest in the at least one terminal device, or n terminal devices whose rates are the smallest in the at least one terminal device, where n is a positive integer.

S330: The monitoring node sends first information to a notified node.

The notified node may include a control plane network element, an application server, a terminal device, or the like. The application server may be a server on the DN shown in FIG. 2.

The first information may be used to indicate the first monitoring result.

Further, in a case that the notified node is a control plane network element or an application server, the notified node may further send the first monitoring result to the terminal device. For example, the notified node may directly send the first monitoring result to the terminal device. Alternatively, after the user plane network element sends the first monitoring result to the control plane network element, the control plane network element sends the first monitoring result to the terminal device by using a non-access stratum (NAS) message or the control plane network element may forward the first monitoring result to the terminal device by using an application server. Alternatively, after the monitoring node sends the first monitoring result to the application server, the application server forwards the first monitoring result to the terminal device. For ease of understanding, subsequent embodiments are all described by using an example in which the notified node is an application server.

For example, the first information may include the first monitoring result and/or an identity of a terminal device corresponding to the first monitoring result. The terminal device corresponding to the first monitoring result herein may refer to a terminal device where a monitoring result of a QoS parameter of the terminal device meets the first preset condition.

In this embodiment of this application, a monitoring node obtains a monitoring result of a quality of service QoS parameter of at least one terminal device, determines, from the monitoring result of the QoS parameter of the at least one terminal device, a first monitoring result that meets a first preset condition, and sends the first monitoring result to a notified node, so that monitoring of the QoS parameter can be implemented.

In S310, in a case that the monitoring node is a user plane network element, the user plane network element may obtain the monitoring result of the quality of service QoS parameter of the at least one terminal device in a plurality of manners, which are specifically as follows:

Manner 1: The user plane network element receives the monitoring result of the QoS parameter from an access network element.

The user plane network element may receive the monitoring result, sent by the access network element, of the QoS parameter of the at least one terminal device.

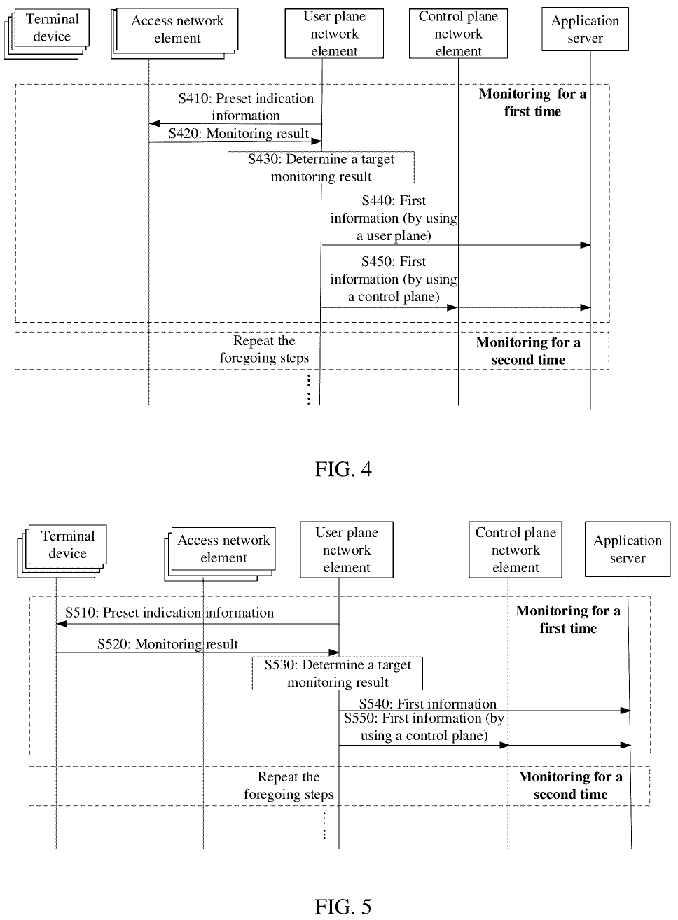

With reference to FIG. 4, the following describes this embodiment in detail by using an example in which the monitoring result is a measurement result of the QoS parameter. As shown in FIG. 4, the following steps may be included.

S410: The user plane network element sends preset indication information to the access network element.

The preset indication information may be carried in a user plane data packet. The preset indication information may be used to trigger the access network element to report the monitoring result of the QoS parameter.

Certainly, in this application, the user plane network element may not send the preset indication information to the access network element. In this case, in a case of obtaining the monitoring result, the access network element directly reports the monitoring result to the user plane network element.

S420: The access network element sends the monitoring result of the QoS parameter of the at least one terminal device to the user plane network element.

The access network element may send the monitoring result of the QoS parameter of the at least one terminal device to the user plane network element by using a user plane.

Optionally, the access network element may send third information to the user plane network element, and the third information may be used to indicate the monitoring result of the QoS parameter of the at least one terminal device.

Certainly, the access network element may also screen the monitoring result of the QoS parameter of the at least one terminal device, and send a screening result to the user plane network element.

S430: The user plane network element determines, from the monitoring result of the QoS parameter of the at least one terminal device, the first monitoring result that meets the first preset condition.

The user plane network element may screen the monitoring result of the QoS parameter of the at least one terminal device based on the first preset condition, to obtain the first monitoring result.

S440: The user plane network element sends first information to an application server. The user plane network element may send the first information to the application server by using the user plane. The first information may be used to indicate the first monitoring result.

Alternatively, in this application, the first information may be sent by using the following step S450.

S450: The user plane network element sends the first information to the application server by using a control plane network element.

That is, the user plane network element may send the first information to the application server by using a control plane.

Further, the application server may further forward the first monitoring result (indicated by the first information) to the terminal device.

In the foregoing embodiment, the access network element and the user plane network element may further receive a monitoring and reporting policy (for example, second information) sent by the control plane network element. For a specific implementation process, reference may be made to a subsequent embodiment corresponding to FIG. 9.

Monitoring is completed for a first time by using the foregoing steps, and subsequently the foregoing steps may be repeated to perform monitoring for a plurality of times.

Manner 2: The user plane network element receives the monitoring result of the QoS parameter from the terminal device.

The user plane network element may receive, from each terminal device in the at least one terminal device, a monitoring result of a QoS parameter of the terminal device.

With reference to FIG. 5, the following describes this embodiment in detail by using an example in which the monitoring result is a measurement result of the QoS parameter. As shown in FIG. 5, the following steps may be included.

S510: The user plane network element sends preset indication information to the terminal device.

The preset indication information may be carried in a user plane data packet. The preset indication information may be used to trigger the terminal device to report the monitoring result of the QoS parameter.

Certainly, in this application, the user plane network element may not send the preset indication information to the terminal device. In this case, in a case of obtaining the monitoring result, the terminal device directly reports the monitoring result to the user plane network element.

S520: The terminal device sends the monitoring result of the QoS parameter of the terminal device to the user plane network element.

The terminal device may monitor the QoS parameter, and send the monitoring result, obtained through monitoring, of the QoS parameter to the user plane network element by using a user plane.

Optionally, the terminal device may send fourth information to the user plane network element, and the fourth information may be used to indicate the monitoring result of the QoS parameter.

S530: The user plane network element determines the first monitoring result that meets the first preset condition according to the monitoring result of the QoS parameter.

The user plane network element may obtain, by using the foregoing steps, monitoring results, sent by a plurality of terminal devices, of QoS parameters. Further, the user plane network element may screen, based on the first preset condition, the monitoring results of the QoS parameters of the plurality of terminal devices, to obtain the first monitoring result.

S540: The user plane network element sends first information to an application server.

The user plane network element may send the first information to the application server by using the user plane. The first information may be used to indicate the first monitoring result.

Alternatively, in this application, the first information may be sent by using the following step S550.

S550: The user plane network element sends the first information to the application server by using a control plane network element.

That is, the user plane network element may send the first information to the application server by using a control plane.

Further, the application server may further forward the first monitoring result (indicated by the first information) to the terminal device.

In the foregoing embodiment, the access network element and the user plane network element may further receive a monitoring and reporting policy (for example, second information) sent by the control plane network element. For a specific implementation process, reference may be made to a subsequent embodiment corresponding to FIG. 9.

Monitoring is completed for a first time by using the foregoing steps, and subsequently the foregoing steps may be repeated to perform monitoring for a plurality of times.

Manner 3: The user plane network element monitors the QoS parameter, to obtain the monitoring result of the QoS parameter.

The user plane network element may monitor a QoS parameter of each terminal device in the at least one terminal device, to obtain the monitoring result of the QoS parameter of the at least one terminal device.

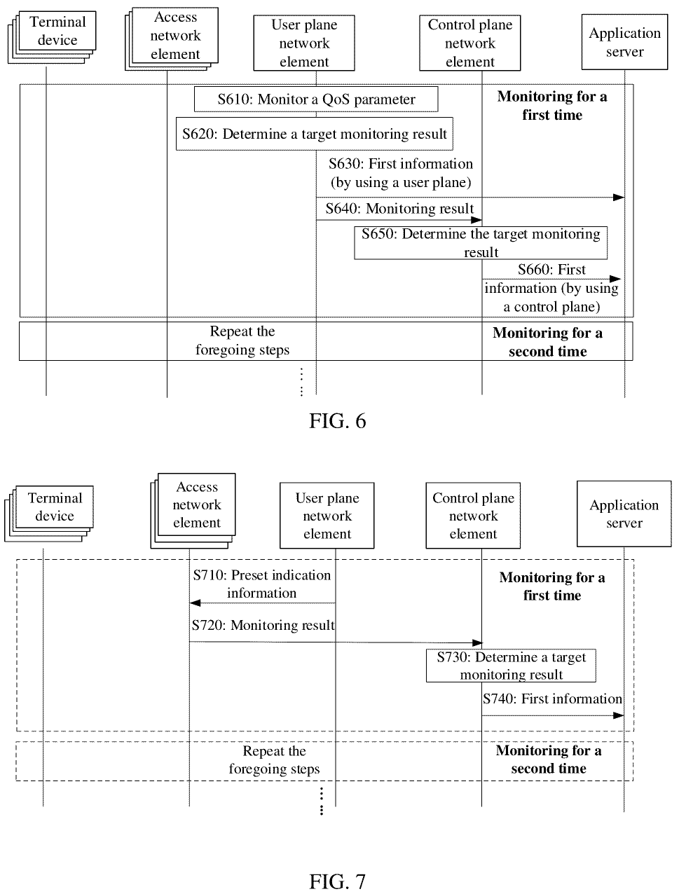

With reference to FIG. 6, the following describes this embodiment in detail by using an example in which the monitoring result is a measurement result of the QoS parameter. As shown in FIG. 6, the following steps may be included.

S610: A user plane network element may monitor a QoS parameter of at least one terminal device, to obtain a monitoring result of the QoS parameter of the at least one terminal device.

S620: The user plane network element determines, from the monitoring result of the QoS parameter of the at least one terminal device, a first monitoring result that meets a first preset condition.

The user plane network element may screen, based on the first preset condition, the monitoring result of the QoS parameter of the at least one terminal device, to obtain a first monitoring result.

S630: The user plane network element sends first information to an application server.

The user plane network element may send the first information to the application server by using a user plane. The first information may be used to indicate the first monitoring result.

Alternatively, in this application, the first information may be sent to the application server by using a control plane network element, which is specifically described in the following steps S640, S650, and S660.

S640: The user plane network element sends the first information to the control plane network element.

That is, the user plane network element may send the first information to the application server by using a control plane.

S650: The control plane network element determines, from the monitoring result of the QoS parameter of the at least one terminal device, a first monitoring result that meets a first preset condition.

The control plane network element may screen, based on a second preset condition, the monitoring result of the QoS parameter of the at least one terminal device, to obtain a second monitoring result. The second preset condition may be the same as or different from the first preset condition.

S660: The control plane network element sends the first information to the application server.

Further, the application server may further forward the first monitoring result (indicated by the first information) to the terminal device.

In the foregoing embodiment, the terminal device and the user plane network element may further receive a monitoring and reporting policy (for example, second information) sent by the control plane network element. For a specific implementation process, reference may be made to a subsequent embodiment corresponding to FIG. 9.

Monitoring is completed for a first time by using the foregoing steps, and subsequently the foregoing steps may be repeated to perform monitoring for a plurality of times.

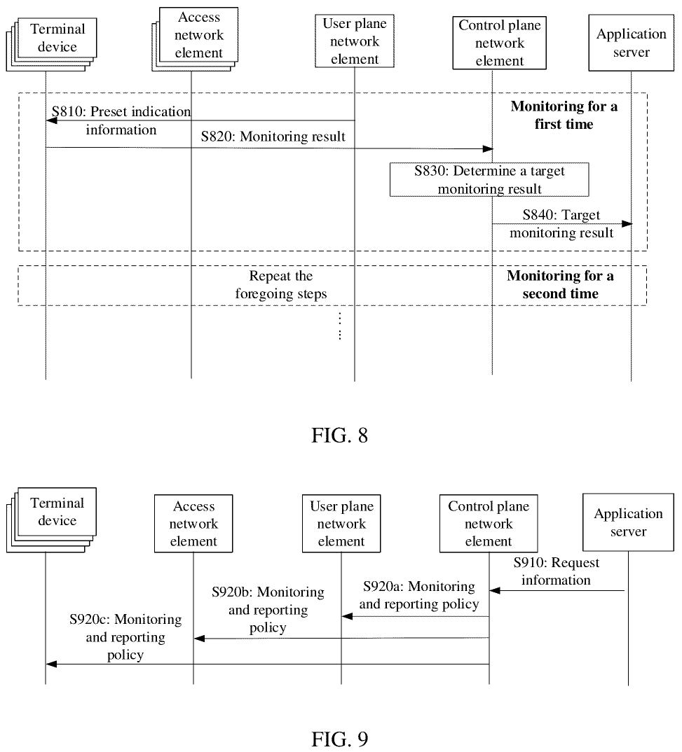

In the foregoing embodiments shown in FIG. 4 to FIG. 6, the terminal device and the access network element send the monitoring result of the QoS parameter to the user plane network element, and report a final screening result to the application server by using the user plane network element. In this application, the terminal device and the access network element may also send the monitoring result of the QoS parameter to the control plane network element, and report the final screening result to the application server by using the control plane network element. For a specific implementation process, reference may be made to the following embodiments corresponding to FIG. 7 and FIG. 8.

In S310, in a case that the monitoring node is a control plane network element, the control plane network element may obtain the monitoring result of the quality of service QoS parameter of the at least one terminal device in a plurality of manners, which are specifically as follows:

With reference to FIG. 7, the following describes an embodiment, in which a user plane network element obtains a monitoring result from an access network element and reports the monitoring result to an application server, in detail by using an example in which the monitoring result is a measurement result of a QoS parameter. As shown in FIG. 7, the following steps may be included.

S710: A user plane network element sends preset indication information to an access network element.

The preset indication information may be carried in a user plane data packet. The preset indication information may be used to trigger the access network element to report a monitoring result of a QoS parameter.

Certainly, in this application, the user plane network element may not send the preset indication information to the access network element. In this case, in a case of obtaining a monitoring result, the access network element directly reports the monitoring result to the user plane network element.

S720: The access network element sends a monitoring result of a QoS parameter of at least one terminal device to the control plane network element.

The access network element may send the monitoring result of the QoS parameter of the at least one terminal device to the control plane network element by using a control plane.

Certainly, the access network element may further screen the monitoring result of the QoS parameter of the at least one terminal device, and send a screening result to the control plane network element.

S730: The control plane network element determines, from the monitoring result of the QoS parameter of the at least one terminal device, a first monitoring result that meets a first preset condition.

The control plane network element may screen the monitoring result of the QoS parameter of the at least one terminal device based on a second preset condition, to obtain a second monitoring result. The second preset condition may be the same as or different from the first preset condition.

S740: The control plane network element sends first information to an application server.

The control plane network element may send the first information to the application server by using a user plane. The first information may be used to indicate the first monitoring result.

Further, the application server may further forward the first monitoring result (indicated by the first information) to the terminal device.

In the foregoing embodiment, the access network element may further receive a monitoring and reporting policy (for example, second information) sent by the control plane network element. For a specific implementation process, reference may be made to a subsequent embodiment corresponding to FIG. 9.

Monitoring is completed for a first time by using the foregoing steps, and subsequently the foregoing steps may be repeated to perform monitoring for a plurality of times.

With reference to FIG. 8, the following describes an embodiment, in which a control plane network element obtains a monitoring result from a terminal device and reports the monitoring result to an application server, in detail by using an example in which the monitoring result is a measurement result of the QoS parameter. As shown in FIG. 8, the following steps may be included.

S810: The user plane network element sends preset indication information to the terminal device.

The preset indication information may be carried in a user plane data packet. The preset indication information may be used to trigger the terminal device to report the monitoring result of the QoS parameter.

Certainly, in this application, the user plane network element may not send the preset indication information to the terminal device. In this case, in a case of obtaining the monitoring result, the terminal device directly reports the monitoring result to the user plane network element.

S820: The terminal device sends the monitoring result of the QoS parameter to the control plane network element.

The terminal device may monitor the QoS parameter, and send the monitoring result, obtained through monitoring, of the QoS parameter of the terminal device to the control plane network element by using the control plane.

S830: The control plane network element determines a first monitoring result that meets a first preset condition according to the monitoring result of the QoS parameter of the terminal device.

The control plane network element may obtain, by using the foregoing steps, monitoring results, sent by a plurality of terminal devices, of QoS parameters. Further, the control plane network element may screen the monitoring result of the QoS parameter of the at least one terminal device based on a second preset condition, to obtain a second monitoring result. The second preset condition may be the same as or different from the first preset condition.

S840: The control plane network element sends first information to the application server.

The control plane network element may send the first information to the application server by using the user plane. The first information may be used to indicate the first monitoring result.

Further, the application server may further forward the first monitoring result (indicated by the first information) to the terminal device.

In the foregoing embodiment, the access network element may further receive a monitoring and reporting policy (for example, second information) sent by the control plane network element. For a specific implementation process, reference may be made to a subsequent embodiment corresponding to FIG. 9.

Monitoring is completed for a first time by using the foregoing steps, and subsequently the foregoing steps may be repeated to perform monitoring for a plurality of times.

With reference to FIG. 9, the following describes in detail an embodiment in which the control plane network element configures a monitoring and reporting policy for the terminal device, the access network element, and/or the user plane network element. As shown in FIG. 9, the following steps may be included.

S910: The application server sends request information to the control plane network element.

The request information may be used to instruct the control plane network element to send the monitoring and reporting policy to the terminal device, the access network element, and/or the user plane network element.

S920: The control plane network element sends the monitoring and reporting policy to the terminal device, the access network element, and/or the user plane network element.

As shown in FIG. 9, step S920 may include steps S920a, S920b, and S920c. The control plane network element may separately send the monitoring and reporting policy to the terminal device, the access network element, and/or the user plane network element according to the request information.

The following separately describes steps S920a, S920b, and S920c in detail.

S920a: The control plane network element sends the monitoring and reporting policy to the user plane network element.

The control plane network element may send second information to the user plane network element. The second information may be used to configure the monitoring and reporting policy of the QoS parameter.

In some possible implementations, the user plane network element may obtain the monitoring result of the QoS parameter of the at least one terminal device according to the second information.

For example, the monitoring and reporting policy may include a first parameter, and the first parameter may be used to configure a to-be-monitored target parameter in the QoS parameter. In this case, the user plane network element may obtain a monitoring result of the target parameter of the at least one terminal device according to the first parameter.

The target parameter may include a rate parameter in the QoS parameter. For example, the rate parameter may include one or more of the following parameters: a guaranteed bit rate GBR, a maximum bit rate MBR, a user equipment aggregated maximum bit rate UE-AMBR, or a session aggregated maximum bit rate Session-AMBR.

For another example, the monitoring and reporting policy may include a second parameter, the second parameter may be used to configure a communication direction of a to-be-monitored target parameter in the QoS parameter, and the communication direction includes uplink and/or downlink. In this case, the user plane network element may obtain an uplink monitoring result and/or a downlink monitoring result of the QoS parameter of the at least one terminal device according to the second parameter.

For another example, the monitoring and reporting policy may include a third parameter, and the third parameter may be used to configure observation duration of a to-be-monitored target parameter in the QoS parameter. In this case, the user plane network element may obtain a monitoring result of the target parameter of the at least one terminal device in the observation duration according to the third parameter.

For another example, the monitoring and reporting policy may include a fourth parameter, and the fourth parameter may be used to configure monitoring duration of a to-be-monitored target parameter in the QoS parameter. The user plane network element may obtain a monitoring result of the target parameter of the at least one terminal device in the monitoring duration according to the fourth parameter.

For another example, the monitoring and reporting policy may include a fifth parameter, and the fifth parameter may be used to configure a to-be-monitored terminal device. In this case, the user plane network element may obtain a monitoring result of the QoS parameter of the to-be-monitored terminal device according to the fifth parameter. The fifth parameter may include an identity of the to-be-monitored terminal device.

In some possible implementations, the user plane network element may send the first information to the control plane network element or the application server according to the second information.

For example, the second information may further include a sixth parameter, and the sixth parameter may be used to configure a reporting manner of the monitoring result. In this case, the user plane network element may send the first information to the control plane network element or the application server according to the sixth parameter.

Optionally, the reporting manner may be used to indicate a reporting time of the monitoring result. In this case, the user plane network element may send the first information to the control plane network element or the application server at the reporting time.

Optionally, the reporting manner may also be used to indicate a reporting period. In this case, the user plane network element may send the first information to the control plane network element or the application server based on the reporting period.

S920b: The control plane network element sends the monitoring and reporting policy to the access network element.

The control plane network element may send second information to the access network element, where the second information may be used to configure the monitoring and reporting policy of the QoS parameter.

In some possible implementations, the access network element may obtain the monitoring result of the QoS parameter of the at least one terminal device according to the second information.

For example, the monitoring and reporting policy may include a first parameter, and the first parameter may be used to configure a to-be-monitored target parameter in the QoS parameter. In this case, the access network element may obtain a monitoring result of the target parameter of the at least one terminal device according to the first parameter.

The target parameter may include a rate parameter in the QoS parameter. For example, the rate parameter includes one or more of the following parameters: a guaranteed bit rate GBR, a maximum bit rate MBR, a user equipment aggregated maximum bit rate UE-AMBR, or a session aggregated maximum bit rate Session-AMBR.

For another example, the monitoring and reporting policy may include a second parameter, the second parameter is used to configure a communication direction of a to-be-monitored target parameter in the QoS parameter, and the communication direction includes uplink and/or downlink. In this case, the access network element may obtain an uplink monitoring result and/or a downlink monitoring result of the QoS parameter of the at least one terminal device according to the second parameter.

For another example, the monitoring and reporting policy may include a third parameter, and the third parameter may be used to configure observation duration of a to-be-monitored target parameter in the QoS parameter. In this case, the access network element may obtain a monitoring result of the target parameter of the at least one terminal device in the observation duration according to the third parameter.

For another example, the monitoring and reporting policy may include a fourth parameter, and the fourth parameter is used to configure monitoring duration of a to-be-monitored target parameter in the QoS parameter. In this case, the access network element may obtain a monitoring result of the target parameter of the at least one terminal device in the monitoring duration according to the fourth parameter.

For another example, the monitoring and reporting policy may include a fifth parameter, and the fifth parameter may be used to configure a to-be-monitored terminal device. In this case, the access network element obtains a monitoring result of the QoS parameter of the to-be-monitored terminal device according to the fifth parameter. The fifth parameter may include an identity of the to-be-monitored terminal device.

In some possible implementations, the access network element may send the third information to the user plane network element or the control plane network element according to the second information. The third information may be used to indicate the monitoring result of the QOS parameter of the at least one terminal device.

For another example, the second information may further include a sixth parameter, and the sixth parameter may be used to configure a reporting manner of the monitoring result. In this case, the access network element may send the third information to the user plane network element or the control plane network element according to the sixth parameter.

The reporting manner may be used to indicate a reporting time of the monitoring result. In this case, the user plane network element may send the third information to the user plane network element or the control plane network element at the reporting time.

The reporting manner may also be used to indicate a reporting period. In this case, the access network element may send the third information to the user plane network element or the control plane network element based on the reporting period.

For another example, the second information may further include a first reporting condition, where the first reporting condition may be used to indicate whether the access network element reports the third information in a case of receiving preset indication information. Correspondingly, in a case of receiving the preset indication information, the access network element may send the third information to the user plane network element or the control plane network element.

S920c: The control plane network element sends the monitoring and reporting policy to the terminal device.

The terminal device may receive second information sent by the control plane network element, where the second information may be used to configure the monitoring and reporting policy of the QoS parameter.

In some possible implementations, the terminal device may perform monitoring according to the second information to obtain the monitoring result of the QoS parameter.

For example, the monitoring and reporting policy may include a first parameter, and the first parameter may be used to configure a to-be-monitored target parameter in the QoS parameter. In this case, the terminal device may perform monitoring according to the first parameter to obtain a monitoring result of the target parameter.

The target parameter may include a rate parameter in the QoS parameter. For example, the rate parameter may include one or more of the following parameters: a guaranteed bit rate GBR, a maximum bit rate MBR, a user equipment aggregated maximum bit rate UE-AMBR, or a session aggregated maximum bit rate Session-AMBR.

For another example, the monitoring and reporting policy may include a second parameter, the second parameter may be used to configure a communication direction of a to-be-monitored target parameter in the QoS parameter, and the communication direction includes uplink and/or downlink. In this case, the terminal device may obtain an uplink monitoring result and/or a downlink monitoring result of the QoS parameter according to the second parameter. For another example, the monitoring and reporting policy may include a third parameter, and the third parameter may be used to configure observation duration of a to-be-monitored target parameter in the QoS parameter. In this case, the terminal device may perform monitoring according to the third parameter to obtain a monitoring result, in the observation duration, of the target parameter.

For another example, the monitoring and reporting policy may include a fourth parameter, and the fourth parameter may be used to configure monitoring duration of a to-be-monitored target parameter in the QoS parameter. In this case, the terminal device may perform monitoring according to the fourth parameter to obtain a monitoring result, in the monitoring duration, of the target parameter.

For another example, the monitoring and reporting policy may include a fifth parameter, and the fifth parameter may be used to configure a to-be-monitored terminal device. Optionally, in a case that the to-be-monitored terminal device includes the terminal device, the terminal device may perform monitoring according to the second information to obtain the monitoring result of the QoS parameter. The fifth parameter may include an identity of the to-be-monitored terminal device.

In some possible implementations, the terminal device may send the fourth information to the user plane network element or the control plane network element according to the second information. The fourth information may be used to indicate the monitoring result of the QoS parameter.

For example, the second information may further include a sixth parameter, and the sixth parameter may be used to configure a reporting manner of the monitoring result. In this case, the terminal device may send the fourth information to the user plane network element or the control plane network element according to the sixth parameter.

The reporting manner may be used to indicate a reporting time of the monitoring result. Correspondingly, the terminal device sends the fourth information to the user plane network element or the control plane network element at the reporting time.

The reporting manner may also be used to indicate a reporting period. Correspondingly, the terminal device may send the fourth information to the user plane network element or the control plane network element based on the reporting period.

For another example, the second information may further include a second reporting condition, where the second reporting condition may be used to indicate whether the terminal device reports the fourth information in a case of receiving preset indication information. Correspondingly, in a case of receiving the preset indication information, the terminal device may send the fourth information to the user plane network element or the control plane network element.

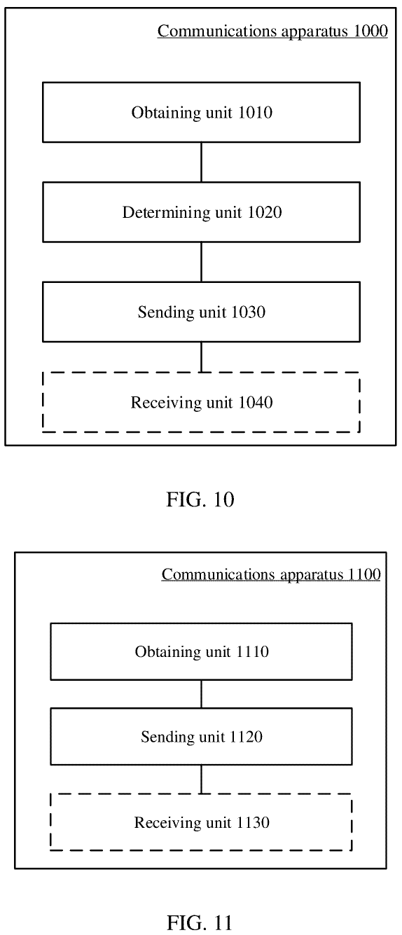

The foregoing describes method embodiments of this application in detail with reference to FIG. 1 to FIG. 9. The following describes apparatus embodiments of this application in detail with reference to FIG. 10 to FIG. 16. It should be understood that the description of the method embodiments corresponds to the description of the apparatus embodiments. Therefore, for parts that are not described in detail, reference may be made to the foregoing method embodiments.

FIG. 10 is a schematic structural diagram of a communications apparatus according to an embodiment of this application. As shown in FIG. 10, the apparatus 1000 includes an obtaining unit 1010, a determining unit 1020, and a sending unit 1030, which are specifically as follows:

the obtaining unit 1010 is configured to obtain a monitoring result of a quality of service QoS parameter of at least one terminal device, where the apparatus is a user plane network element or a control plane network element;

the determining unit 1020 is configured to determine, from the monitoring result of the QoS parameter of the at least one terminal device, a first monitoring result that meets a first preset condition; and the sending unit 1030 is configured to send first information to a notified node, where the first information is used to indicate the first monitoring result, and the notified node includes a control plane network element, an application server, or a terminal device.

Optionally, the monitoring result of the QoS parameter includes a guarantee status of a QoS flow, a current rate obtained through measurement, current reliability, and/or a current latency.

Optionally, the first information includes the first monitoring result and/or an identity of a terminal device corresponding to the first monitoring result.

Optionally, the obtaining unit 1010 is specifically configured to receive, from each terminal device in the at least one terminal device, a monitoring result of a QoS parameter of the terminal device.

Optionally, the obtaining unit 1010 is specifically configured to receive the monitoring result of the QoS parameter of the at least one terminal device from an access network element.

Optionally, the obtaining unit is specifically configured to monitor the QoS parameter of each terminal device in the at least one terminal device, to obtain the monitoring result of the QoS parameter of the at least one terminal device.

Optionally, the apparatus 1000 further includes a receiving unit 1040, configured to receive second information sent by the control plane network element, where the second information is used to configure a monitoring and reporting policy of the QoS parameter.

Optionally, the obtaining unit 1010 is specifically configured to obtain the monitoring result of the QoS parameter of the at least one terminal device according to the second information.

Optionally, the monitoring and reporting policy includes a first parameter, and the first parameter is used to configure a to-be-monitored target parameter in the QoS parameter. The obtaining unit 1010 is specifically configured to obtain a monitoring result of the target parameter of the at least one terminal device according to the first parameter.

Optionally, the target parameter includes a rate parameter in the QoS parameter.

Optionally, the rate parameter includes one or more of the following parameters: a guaranteed bit rate GBR, a maximum bit rate MBR, a user equipment aggregated maximum bit rate UE-AMBR, or a session aggregated maximum bit rate Session-AMBR.

Optionally, the monitoring and reporting policy includes a second parameter, and the second parameter is used to configure a communication direction of a to-be-monitored target parameter in the QoS parameter, and the communication direction includes uplink and/or downlink. The obtaining unit 1010 is specifically configured to obtain an uplink monitoring result and/or a downlink monitoring result of the QoS parameter of the at least one terminal device according to the second parameter.

Optionally, the monitoring and reporting policy includes a third parameter, and the third parameter is used to configure observation duration of a to-be-monitored target parameter in the QoS parameter. The obtaining unit 1010 is specifically configured to obtain a monitoring result of the target parameter of the at least one terminal device in the observation duration according to the third parameter.

Optionally, the monitoring and reporting policy includes a fourth parameter, and the fourth parameter is used to configure monitoring duration of a to-be-monitored target parameter in the QoS parameter. The obtaining unit 1010 is specifically configured to obtain a monitoring result of the target parameter of the at least one terminal device in the monitoring duration according to the fourth parameter.

Optionally, the monitoring and reporting policy includes a fifth parameter, and the fifth parameter is used to configure a to-be-monitored terminal device. The obtaining unit 1010 is specifically configured to obtain a monitoring result of the QoS parameter of the to-be-monitored terminal device according to the fifth parameter.

Optionally, the fifth parameter includes an identity of the to-be-monitored terminal device.

Optionally, the sending unit 1030 is specifically configured to send the first information to the notified node according to the second information.

Optionally, the second information further includes a sixth parameter, and the sixth parameter is used to configure a reporting manner of the monitoring result. The sending unit 1030 is specifically configured to send the first information to the notified node according to the sixth parameter.

Optionally, the reporting manner is used to indicate a reporting time of the monitoring result. The sending unit 1030 is specifically configured to send the first information to the notified node at the reporting time.

Optionally, the reporting manner is used to indicate a reporting period. The sending unit 1030 is specifically configured to send the first information to the notified node based on the reporting period.

Optionally, the first preset condition includes: a terminal device whose rate is greater than or less than a preset threshold in the at least one terminal device, or n terminal devices whose rates are the largest or the smallest in the at least one terminal device, where n is a positive integer. The first information includes an identity and/or a monitoring result of a terminal device that meets the first preset condition.

FIG. 11 is a schematic structural diagram of a communications apparatus according to an embodiment of this application. The communications apparatus 800 in FIG. 8 specifically includes:

an obtaining unit 1110, configured to obtain a monitoring result of a quality of service QoS parameter of at least one terminal device; and

a sending unit 1120, configured to send third information to a monitoring node, where the third information is used to indicate the monitoring result of the QoS parameter of the at least one terminal device, and the monitoring node is a user plane network element or a control plane network element.

Optionally, the monitoring result of the QoS parameter includes a guarantee status of a QoS flow, a current rate obtained through measurement, current reliability, and/or a current latency.

Optionally, the third information includes the monitoring result of the QoS parameter of the at least one terminal device and/or an identity of the at least one terminal device.

Optionally, the obtaining unit 1110 is specifically configured to receive, from each terminal device in the at least one terminal device, a monitoring result of a QoS parameter of the terminal device.

Optionally, the apparatus 1100 further includes a receiving unit 1130, configured to receive second information sent by the control plane network element, where the second information is used to configure a monitoring and reporting policy of the QoS parameter.

Optionally, the obtaining unit 1110 is specifically configured to obtain the monitoring result of the QoS parameter of the at least one terminal device according to the second information.

Optionally, the monitoring and reporting policy includes a first parameter, and the first parameter is used to configure a to-be-monitored target parameter in the QoS parameter. The obtaining unit 1110 is specifically configured to obtain a monitoring result of the target parameter of the at least one terminal device according to the first parameter.

Optionally, the target parameter includes a rate parameter in the QoS parameter.

Optionally, the rate parameter includes one or more of the following parameters: a guaranteed bit rate GBR, a maximum bit rate MBR, a user equipment aggregated maximum bit rate UE-AMBR, or a session aggregated maximum bit rate Session-AMBR.

Optionally, the monitoring and reporting policy includes a second parameter, and the second parameter is used to configure a communication direction of a to-be-monitored target parameter in the QoS parameter, and the communication direction includes uplink and/or downlink. The obtaining unit 1110 is specifically configured to obtain an uplink monitoring result and/or a downlink monitoring result of the QoS parameter of the at least one terminal device according to the second parameter.

Optionally, the monitoring and reporting policy includes a third parameter, and the third parameter is used to configure observation duration of a to-be-monitored target parameter in the QoS parameter. The obtaining unit 1110 is specifically configured to obtain a monitoring result, of the target parameter of the at least one terminal device, in the observation duration according to the third parameter.

Optionally, the monitoring and reporting policy includes a fourth parameter, and the fourth parameter is used to configure monitoring duration of a to-be-monitored target parameter in the QoS parameter. The obtaining unit 1110 is specifically configured to obtain a monitoring result, of the target parameter of the at least one terminal device, in the monitoring duration according to the fourth parameter.

Optionally, the monitoring and reporting policy includes a fifth parameter, and the fifth parameter is used to configure a to-be-monitored terminal device. The obtaining unit 1110 is specifically configured to obtain a monitoring result of the QoS parameter of the to-be-monitored terminal device according to the fifth parameter.

Optionally, the fifth parameter includes an identity of the to-be-monitored terminal device.

Optionally, the sending unit 1120 is specifically configured to send the third information to the monitoring node according to the second information.

Optionally, the second information further includes a sixth parameter, and the sixth parameter is used to configure a reporting manner of the monitoring result. The sending unit 1120 is specifically configured to send the third information to the monitoring node according to the sixth parameter.

Optionally, the reporting manner is used to indicate a reporting time of the monitoring result. The sending unit 1120 is specifically configured to send the third information to the monitoring node at the reporting time.

Optionally, the reporting manner is used to indicate a reporting period. The sending unit 1120 is specifically configured to send the third information to the monitoring node based on the reporting period.

Optionally, the second information further includes a first reporting condition, and the first reporting condition is used to indicate whether the apparatus reports the third information in a case of receiving preset indication information. The sending unit 1120 is specifically configured to: send, in a case of receiving the preset indication information, the third information to the monitoring node.

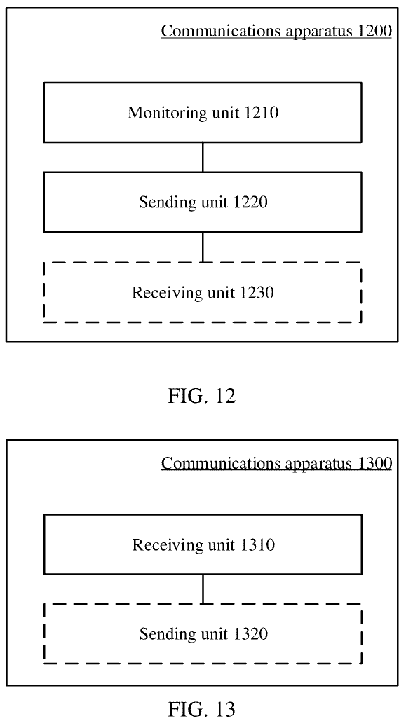

FIG. 12 is a schematic structural diagram of a communications apparatus according to an embodiment of this application. The communications apparatus 1200 in FIG. 12 specifically includes:
a monitoring unit 1210, configured to perform monitoring to obtain a monitoring result of a quality of service QoS parameter; and
a sending unit 1220, configured to send fourth information to a monitoring node, where the fourth information is used to indicate the monitoring result of the QoS parameter, the monitoring node includes a control plane network element, an application server, or a terminal device, and the monitoring node is a user plane network element or a control plane network element.

Optionally, the monitoring result of the QoS parameter includes a guarantee status of a QoS flow, a current rate obtained through measurement, current reliability, and/or a current latency.

Optionally, the fourth information includes the monitoring result of the QoS parameter of the at least one terminal device and/or an identity of the at least one terminal device.

Optionally, the apparatus 1200 further includes a receiving unit 1230, configured to receive second information sent by a control plane network element, where the second information is used to configure a monitoring and reporting policy of the QoS parameter.

Optionally, the monitoring unit 1210 is specifically configured to perform monitoring according to the second information to obtain the monitoring result of the QoS parameter.

Optionally, the monitoring and reporting policy includes a first parameter, and the first parameter is used to configure a to-be-monitored target parameter in the QoS parameter. The monitored unit 1210 is specifically configured to perform monitoring according to the first parameter to obtain a monitoring result of the target parameter.

Optionally, the target parameter includes a rate parameter in the QoS parameter.

Optionally, the rate parameter includes one or more of the following parameters: a guaranteed bit rate GBR, a maximum bit rate MBR, a user equipment aggregated maximum bit rate UE-AMBR, or a session aggregated maximum bit rate Session-AMBR.

Optionally, the monitoring and reporting policy includes a second parameter, and the second parameter is used to configure a communication direction of a to-be-monitored target parameter in the QoS parameter, and the communication direction includes uplink and/or downlink. The monitoring unit 1210 is specifically configured to perform monitoring according to the second parameter to obtain an uplink monitoring result and/or a downlink monitoring result of the QoS parameter.

Optionally, the monitoring and reporting policy includes a third parameter, and the third parameter is used to configure observation duration of a to-be-monitored target parameter in the QoS parameter. The monitoring unit 1210 is specifically configured to perform monitoring according to the third parameter to obtain a monitoring result of the target parameter in the observation duration.

Optionally, the monitoring and reporting policy includes a fourth parameter, and the fourth parameter is used to configure monitoring duration of a to-be-monitored target parameter in the QoS parameter. The monitoring unit 1210 is specifically configured to perform monitoring according to the fourth parameter to obtain a monitoring result, in the monitoring duration, of the target parameter.

Optionally, the monitoring and reporting policy includes a fifth parameter, and the fifth parameter is used to configure a to-be-monitored terminal device. The monitoring unit 1210 is specifically configured to: in a case that the to-be-monitored terminal device includes the terminal device, perform monitoring according to the second information to obtain the monitoring result of the QoS parameter.

Optionally, the fifth parameter includes an identity of the to-be-monitored terminal device.

Optionally, the sending unit 1220 is specifically configured to send the fourth information to the monitoring node according to the second information.

Optionally, the second information further includes a sixth parameter, and the sixth parameter is used to configure a reporting manner of the monitoring result. The sending unit 1220 is specifically configured to send the fourth information to the monitoring node according to the sixth parameter.

Optionally, the reporting manner is used to indicate a reporting time of the monitoring result. The sending unit 1220 is specifically configured to send the fourth information to the monitoring node at the reporting time.

Optionally, the reporting manner is used to indicate a reporting period. The sending unit 1220 is specifically configured to send the fourth information to the monitoring node based on the reporting period.

Optionally, the second information further includes a second reporting condition, and the second reporting condition is used to indicate whether the terminal device reports the fourth information in a case of receiving preset indication information. The sending unit 1220 is specifically configured to: send, in a case of receiving the preset indication information, the fourth information to the monitoring node.

FIG. 13 is a schematic structural diagram of a communications apparatus according to an embodiment of this application. The communications apparatus 1300 in FIG. 13 specifically includes:

a receiving unit 1310, configured to receive first information sent by a monitoring node, where the first information is used to indicate a first monitoring result, that meets a first preset condition, in a monitoring result of a quality of service QoS parameter of at least one terminal device; the apparatus includes a control plane network element, an application server, or a terminal device, and the monitoring node is a user plane network element or a control plane network element.

Optionally, the monitoring result of the QoS parameter includes a guarantee status of a QoS flow, a current rate obtained through measurement, current reliability, and/or a current latency.

Optionally, the first information includes the first monitoring result and/or an identity of a terminal device corresponding to the first monitoring result.

Optionally, the apparatus further includes a sending unit 1320, configured to send second information to the monitoring node, where the second information is used to configure a monitoring and reporting policy of the QoS parameter.

Optionally, the monitoring and reporting policy includes a first parameter, and the first parameter is used to configure a to-be-monitored target parameter in the QoS parameter.

Optionally, the target parameter includes a rate parameter in the QoS parameter.

Optionally, the rate parameter includes one or more of the following parameters: a guaranteed bit rate GBR, a maximum bit rate MBR, a user equipment aggregated maximum bit rate UE-AMBR, or a session aggregated maximum bit rate Session-AMBR.

Optionally, the monitoring and reporting policy includes a second parameter, the second parameter is used to configure a communication direction of a to-be-monitored target parameter in the QoS parameter, and the communication direction includes uplink and/or downlink.

Optionally, the monitoring and reporting policy includes a third parameter, and the third parameter is used to configure observation duration of a to-be-monitored target parameter in the QoS parameter.

Optionally, the monitoring and reporting policy includes a fourth parameter, and the fourth parameter is used to configure monitoring duration of a to-be-monitored target parameter in the QoS parameter.

Optionally, the monitoring and reporting policy includes a fifth parameter, and the fifth parameter is used to configure a to-be-monitored terminal device.

Optionally, the fifth parameter includes an identity of the to-be-monitored terminal device.

Optionally, the receiving unit 1310 is specifically configured to receive, according to the second information, the first information sent by the monitoring node.

Optionally, the second information further includes a sixth parameter, and the sixth parameter is used to configure a reporting manner of the monitoring result. The receiving unit 1310 is specifically configured to receive, according to the sixth parameter, the first information sent by the monitoring node.

Optionally, the reporting manner is used to indicate a reporting time of the monitoring result. The receiving unit 1310 is specifically configured to receive, at the reporting time, the first information sent by the monitoring node.

Optionally, the reporting manner is used to indicate a reporting period. The receiving unit 1310 is specifically configured to receive, based on the reporting period, the first information sent by the monitoring node.

Optionally, the first preset condition includes: a terminal device whose rate is greater than or less than a preset threshold in the at least one terminal device, or n terminal devices whose rates are the largest or the smallest in the at least one terminal device, where n is a positive integer.

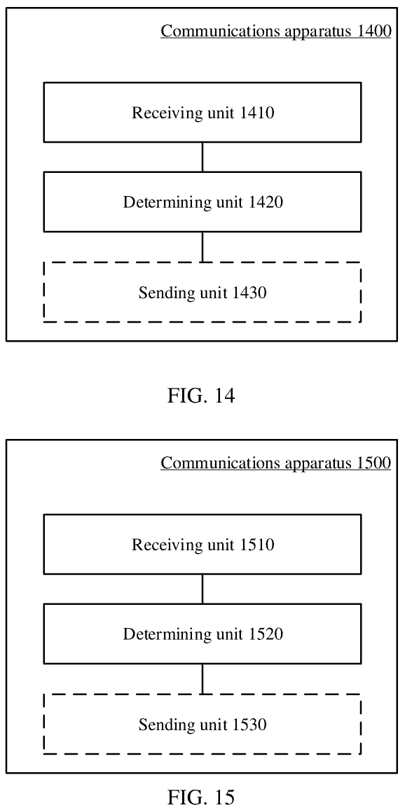

FIG. 14 is a schematic structural diagram of a communications apparatus according to an embodiment of this application. The communications apparatus 1400 in FIG. 14 specifically includes:

a receiving unit 1410, configured to receive third information sent by an access network element, where the third information is used to indicate a monitoring result of a quality of service QoS parameter of at least one terminal device; and a determining unit 1420, configured to determine, from the monitoring result of the QoS parameter of the at least one terminal device, a second monitoring result that meets a second preset condition.

Optionally, the monitoring result of the QoS parameter includes a guarantee status of a QoS flow, a current rate obtained through measurement, current reliability, and/or a current latency.

Optionally, the third information includes the monitoring result of the QoS parameter of the at least one terminal device and/or an identity of the at least one terminal device.

Optionally, the apparatus further includes a sending unit 1430, configured to send second information to the access network element, where the second information is used to configure a monitoring and reporting policy of the QoS parameter.

Optionally, the monitoring and reporting policy includes a first parameter, and the first parameter is used to configure a to-be-monitored target parameter in the QoS parameter.

Optionally, the target parameter includes a rate parameter in the QoS parameter.

Optionally, the rate parameter includes one or more of the following parameters: a guaranteed bit rate GBR, a maximum bit rate MBR, a user equipment aggregated maximum bit rate UE-AMBR, or a session aggregated maximum bit rate Session-AMBR.

Optionally, the monitoring and reporting policy includes a second parameter, the second parameter is used to configure a communication direction of a to-be-monitored target parameter in the QoS parameter, and the communication direction includes uplink and/or downlink.

Optionally, the monitoring and reporting policy includes a third parameter, and the third parameter is used to configure observation duration of a to-be-monitored target parameter in the QoS parameter.

Optionally, the monitoring and reporting policy includes a fourth parameter, and the fourth parameter is used to configure monitoring duration of a to-be-monitored target parameter in the QoS parameter.

Optionally, the monitoring and reporting policy includes a fifth parameter, and the fifth parameter is used to configure a to-be-monitored terminal device.

Optionally, the fifth parameter includes an identity of the to-be-monitored terminal device.

Optionally, the receiving unit 1410 is specifically configured to receive, according to the second information, the third information sent by the access network element.

Optionally, the second information further includes a sixth parameter, and the sixth parameter is used to configure a reporting manner of the monitoring result. The receiving unit 1410 is specifically configured to receive, according to the sixth parameter, the third information sent by the access network element.

Optionally, the reporting manner is used to indicate a reporting time of the monitoring result. The receiving unit 1410 is specifically configured to receive, at the reporting time, the third information sent by the access network element.

Optionally, the reporting manner is used to indicate a reporting period. The receiving unit 1410 is specifically configured to receive, based on the reporting period, the first information sent by the access network element.

Optionally, the second preset condition includes: a terminal device whose rate is greater than or less than a preset threshold in the at least one terminal device, or n terminal devices whose rates are the largest or the smallest in the at least one terminal device, where n is a positive integer.

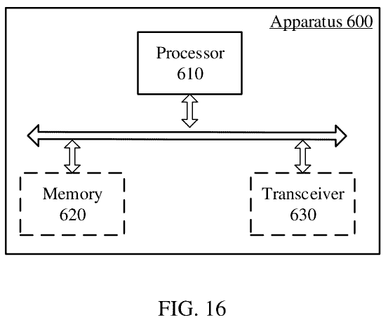

FIG. 15 is a schematic structural diagram of a communications apparatus according to an embodiment of this application. The communications apparatus 1500 in FIG. 15 specifically includes:

a receiving unit 1510, configured to receive fourth information sent by a terminal device, where the fourth information is used to indicate a monitoring result of the QoS parameter; and a determining unit 1520, configured to determine a third monitoring result that meets a third preset condition according to the monitoring result of the QoS parameter.

Optionally, the monitoring result of the QoS parameter includes a guarantee status of a QoS flow, a current rate obtained through measurement, current reliability, and/or a current latency.

Optionally, the fourth information includes the monitoring result of the QoS parameter of the at least one terminal device and/or an identity of the at least one terminal device.

Optionally, the apparatus 1500 further includes a sending unit 1530, configured to send second information to the terminal device, where the second information is used to configure a monitoring and reporting policy of the QoS parameter.

Optionally, the monitoring and reporting policy includes a first parameter, and the first parameter is used to configure a to-be-monitored target parameter in the QoS parameter.

Optionally, the target parameter includes a rate parameter in the QoS parameter.

Optionally, the rate parameter includes one or more of the following parameters: a guaranteed bit rate GBR, a maximum bit rate MBR, a user equipment aggregated maximum bit rate UE-AMBR, or a session aggregated maximum bit rate Session-AMBR.

Optionally, the monitoring and reporting policy includes a second parameter, the second parameter is used to configure a communication direction of a to-be-monitored target parameter in the QoS parameter, and the communication direction includes uplink and/or downlink.

Optionally, the monitoring and reporting policy includes a third parameter, and the third parameter is used to configure observation duration of a to-be-monitored target parameter in the QoS parameter.

Optionally, the monitoring and reporting policy includes a fourth parameter, and the fourth parameter is used to configure monitoring duration of a to-be-monitored target parameter in the QoS parameter.

Optionally, the monitoring and reporting policy includes a fifth parameter, and the fifth parameter is used to configure a to-be-monitored terminal device.

Optionally, the fifth parameter includes an identity of the to-be-monitored terminal device.

Optionally, the receiving unit 1510 is specifically configured to receive, according to the second information, the fourth information sent by the terminal device.

Optionally, the second information further includes a sixth parameter, and the sixth parameter is used to configure a reporting manner of the monitoring result. The receiving unit 1510 is specifically configured to receive, according to the sixth parameter, the fourth information sent by the terminal device.

Optionally, the reporting manner is used to indicate a reporting time of the monitoring result. The receiving unit 1510 is specifically configured to receive, at the reporting time, the fourth information sent by the terminal device.

Optionally, the reporting manner is used to indicate a reporting period. The receiving unit 1510 is specifically configured to receive, based on the reporting period, the fourth information sent by the terminal device.

Optionally, the third preset condition includes: a terminal device whose rate is greater than or less than a preset threshold in the at least one terminal device, or n terminal devices whose rates are the largest or the smallest in the at least one terminal device, where n is a positive integer.

FIG. 16 is a schematic structural diagram of an apparatus according to an embodiment of this application. The dashed lines in FIG. 16 indicate that the unit or module is optional. The apparatus 600 may be configured to implement the methods described in the method embodiments. The apparatus 600 may be a chip or a communications apparatus.

The apparatus 600 may include one or more processors 610. The processor 610 may allow the apparatus 600 to implement the methods described in the foregoing method embodiments. The processor 610 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 600 may further include one or more memories 620. The memory 620 stores a program, where the program may be executed by the processor 610, to cause the processor 610 to execute the methods described in the foregoing method embodiments. The memory 620 may be independent of the processor 610 or may be integrated into the processor 610.

The apparatus 600 may further include a transceiver 630. The processor 610 may communicate with another device or chip by using the transceiver 630. For example, the processor 610 may send data to and receive data from another device or chip by using the transceiver 630.

An embodiment of this application further provides a computer-readable storage medium for storing a program. The computer-readable storage medium may be applied to the communications apparatus provided in embodiments of this application, and the program causes a computer to execute the methods to be executed by the communications apparatus in various embodiments of this application.

An embodiment of this application further provides a computer program product. The computer program product includes a program. The computer program product may be applied to the communications apparatus provided in embodiments of this application, and the program causes a computer to execute the methods to be executed by the communications apparatus in various embodiments of this application.

An embodiment of this application further provides a computer program. The computer program may be applied to a communications apparatus provided in embodiments of this application, and the computer program causes a computer to execute the methods to be executed by the communications apparatus in various embodiments of this application.

It should be understood that, in embodiments of this application, “B that is corresponding to A” means that B is associated with A, and B may be determined based on A. However, it should also be understood that, determining B based on A does not mean determining B based on only A, but instead B may be determined based on A and/or other information.

It should be understood that, in this specification, the term “and/or” is merely an association relationship that describes associated objects, and represents that there may be three relationships. For example, A and/or B may represent three cases: only A exists, both A and B exist, and only B exists. In addition, the character “/” herein generally indicates an “or” relationship between the associated objects.

It should be understood that, in embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented by using some interfaces. The indirect couplings or communication connections between apparatuses or units may be implemented in electrical, mechanical, or other forms.

The units described as separate components may be or may not be physically separated, and the components displayed as units may be or may not be physical units, that is, may be located in a same place or distributed on a plurality of network units. Some or all of the units may be selected according to actual needs to achieve the objective of the solutions of embodiments.

In addition, function units in embodiments of this application may be integrated into a same processing unit, or each of the units may exist alone physically, or two or more units may be integrated into a same unit.

All or some of the foregoing embodiments may be implemented by using software, hardware, firmware, or any combination thereof. In a case that embodiments are implemented by using software, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any usable medium readable by the computer, or a data storage device, such as a server or a data center, with one or more usable media integrated. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A communications apparatus, wherein the communications apparatus is a monitoring node and comprises:
a memory configured to store a program; and
a processor configured to invoke the program in the memory to cause the communications apparatus to perform:
obtaining a monitoring result of a quality of service (QOS) parameter of at least one terminal device, wherein the monitoring node is a user plane network element or a control plane network element;
determining, from the monitoring result of the QoS parameter of the at least one terminal device, a first monitoring result that meets a first preset condition; and
sending, first information to a notified node, wherein the first information is used to indicate the first monitoring result, and the notified node comprises a control plane network element, an application server, or a terminal device.

2. The apparatus according to claim 1, wherein the monitoring result of the QoS parameter comprises a guarantee status of a QoS flow, a current rate, current reliability, and/or a current latency.

3. The apparatus according to claim 1, wherein the first information comprises the first monitoring result and/or an identity of a terminal device corresponding to the first monitoring result.

4. The apparatus according to claim 1, wherein the obtaining a monitoring result of a QoS parameter of at least one terminal device comprises:
receiving the monitoring result, sent by an access network element, of the QoS parameter of the at least one terminal device.

5. The apparatus according to claim 1, wherein the processor is configured to invoke the program in the memory to cause the communications apparatus to further perform:
receiving second information sent by the notified node, wherein the second information is used to configure a monitoring and reporting policy of the QoS parameter.

6. The apparatus according to claim 5, wherein the obtaining a monitoring result of a QoS parameter of at least one terminal device comprises:
obtaining the monitoring result of the QoS parameter of the at least one terminal device according to the second information.

7. The apparatus according to claim 6, wherein the monitoring and reporting policy comprises a second parameter, the second parameter is used to configure a communication direction of a to-be-monitored target parameter in the QoS parameter, and the communication direction comprises uplink and/or downlink; and
the obtaining the monitoring result of the QoS parameter of the at least one terminal device according to the second information comprises:
obtaining an uplink monitoring result and/or a downlink monitoring result of the QoS parameter of the at least one terminal device according to the second parameter.

8. The apparatus according to claim 6, wherein the monitoring and reporting policy comprises a third parameter, and the third parameter is used to configure observation duration of a to-be-monitored target parameter in the QoS parameter; and
the obtaining the monitoring result of the QoS parameter of the at least one terminal device according to the second information comprises:
obtaining a monitoring result of the target parameter of the at least one terminal device in the observation duration according to the third parameter.

9. A communications apparatus, wherein the communications apparatus is a notified node and comprises:
a memory configured to store a program; and
a processor configured to invoke the program in the memory to cause the communications apparatus to perform:
receiving first information sent by a monitoring node, wherein the first information is used to indicate a first monitoring result, that meets a first preset condition, in a monitoring result of a quality of service (QOS) parameter of at least one terminal device, the notified node comprises a control plane network element, an application server, or a terminal device, and the monitoring node is a user plane network element or a control plane network element.

10. The apparatus according to claim 9, wherein the monitoring result of the QoS parameter comprises a guarantee status of a QoS flow, a current rate obtained through measurement, current reliability, and/or a current latency.

11. The apparatus according to claim 9, wherein the first information comprises the first monitoring result and/or an identity of a terminal device corresponding to the first monitoring result.

12. The apparatus according to claim 9, wherein the processor is configured to invoke the program in the memory to cause the communications apparatus to further perform:
sending second information to the monitoring node, wherein the second information is used to configure a monitoring and reporting policy of the QoS parameter.

13. The apparatus according to claim 12, wherein the monitoring and reporting policy comprises a second parameter, the second parameter is used to configure a communication direction of a to-be-monitored target parameter in the QoS parameter, and the communication direction comprises uplink and/or downlink.

14. The apparatus according to claim 12, wherein the monitoring and reporting policy comprises a third parameter, and the third parameter is used to configure observation duration of a to-be-monitored target parameter in the QoS parameter.

15. The apparatus according to claim 12, wherein the receiving first information sent by a monitoring node comprises:
receiving, according to the second information, the first information sent by the monitoring node.

16. A communications apparatus, wherein the communications apparatus is an access network element and comprises:
a memory configured to store a program; and
a processor configured to invoke the program in the memory to cause the communications apparatus to perform:
obtaining a monitoring result of a quality of service (QOS) parameter of at least one terminal device; and
sending third information to a monitoring node, wherein the third information is used to indicate the monitoring result of the QoS parameter of the at least one terminal device, and the monitoring node is a user plane network element or a control plane network element.

17. The apparatus according to claim 16, wherein the monitoring result of the QoS parameter comprises a guarantee status of a QoS flow, a current rate obtained through measurement, current reliability, and/or a current latency.

18. The apparatus according to claim 16, wherein the third information comprises the monitoring result of the QoS parameter of the at least one terminal device and/or an identity of the at least one terminal device.

19. The apparatus according to claim 16, wherein the processor is configured to invoke the program in the memory to cause the communications apparatus to further perform:
receiving second information sent by the control plane network element, wherein the second information is used to configure a monitoring and reporting policy of the QoS parameter.

20. The apparatus according to claim 19, wherein the monitoring and reporting policy comprises a second parameter, the second parameter is used to configure a communication direction of a to-be-monitored target parameter in the QoS parameter, and the communication direction comprises uplink and/or downlink; and
the obtaining the monitoring result of the QoS parameter of the at least one terminal device according to the second information comprises:
obtaining an uplink monitoring result and/or a downlink monitoring result of the QoS parameter of the at least one terminal device according to the second parameter.
